(19) United States
(12) Patent Application Publication
(10) Pub. No.: US 2008/0216367 A1
(43) Pub. Date: Sep. 11, 2008

(54) Road-Marking System

(75) Inventor: Lucas Leo Desiree Van Der Poel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,239

(22) PCT Filed: Aug. 18, 2004
(86) PCT No.: PCT/IB04/51481

§ 371 Date: Feb. 28, 2006

(30) Foreign Application Priority Data
Sep. 4, 2003 (EP) 03103288.1

(51) Int. Cl. G09F 13/00

(52) U.S. Cl. 40/541

(57) ABSTRACT

The road-marking system for influencing the distance between vehicles (6, 6′, . . . ) traveling over a roadway (10) comprises: a plurality of road-marking units (3; 3′, 3″, . . . ; 4, 4′, . . . ), the road-marking units being provided with light means for emitting or reflecting light in the direction of a driver of the vehicle (6, 6′, . . . ). In operation, a set of the road-marking units (4, 4′, . . . ) is in an active state, while the remainder of the road-marking units (3; 3′, 3″, . . . ) is in an inactive state. The distance between the active road-marking units (4, 4′, . . . ) in the set is indicative of the desired distance between the vehicles (6, 6′, . . . ). Preferably, the light emitted or reflected by the set of active road-marking units (4, 4′, . . . ) is tuned in response to conditions during the day or during the night.

The invention relates to a road-marking system for influencing the distance between vehicles traveling over a roadway.

Road-marking systems are used in traffic control systems for marking traffic routes for vehicles, such as roads for cars and other road users. One of the methods used by traffic planners in their attempts to reduce traffic jams is a so-called “tidal flow system”. In such a road-marking system, the direction of the traffic of multi-lane roads is changed for one or more lanes in accordance with the direction of the main flow of traffic. In an alternative embodiment, the number of lanes available to traffic moving in a specific direction is increased or reduced in dependence on the amount of traffic.

Road-marking systems for influencing the distance between vehicles traveling over a roadway are known in the art. A manner of influencing the distance between vehicles traveling over a roadway is to apply so-called chevrons or V-shaped markings on the roadway. Such chevrons may be applied on the surface of the roadway by means of paint or by means of suitable thermoplastic processes. The chevrons indicate a safe distance between vehicles traveling over the roadway.

A drawback of the known road-marking system is that said road-marking system cannot be used to dynamically influence the distance between vehicles traveling over the roadway.

The invention has for its object to eliminate the above disadvantage wholly or partly. According to the invention, a road-marking system for influencing the distance between vehicles traveling over a roadway of the kind mentioned in the opening paragraph for this purpose comprises:
a plurality of road-marking units,
the road-marking units being provided with light means for emitting or reflecting light in the direction of a driver of the vehicle,
a set of the road-marking units of which in operation a part is in an active state, while the remainder of the road-marking units is in an inactive state,
the distance between the road-marking units in the set being indicative of the desired distance between the vehicles.

An “active state” of a road-marking unit in the present description and claims is understood to be a state in which the light means for emitting or reflecting light in the road-marking unit emits or reflects light. A road-marking unit being in an “active state” does not necessary imply that energy is required to maintain the “active state”. In addition, an “inactive state” of a road-marking unit is understood to be a state in which the light means for emitting or reflecting light in the road-marking unit does not emit or reflect light.

The distance between the visible road-marking units can be influenced in that the road-marking units are selectively made active or inactive. When, by way of example, every second road-marking unit is in an active state (switched on) while the remaining number of road-marking units is in an inactive state (switched off), the distance between the road-marking units as perceived by a driver of a vehicle traveling over a roadway is twice that in the situation where all road-marking units are in an active state. The distance between active road-marking units can be adapted in dependence on the circumstances. Such circumstances may be traffic intensity, weather conditions, etcetera.

The distance between the visible road-marking units can be dynamically influenced in that road-marking units are selectively brought into the active state. A dynamic road-marking system for influencing the distance between vehicles traveling over a roadway is realized in this manner. The safety of the traffic is improved by the use of a dynamic road-marking system according to the invention.

The road-marking units or chevrons in the known road-marking system are painted on the surface of the roadway, and a guidepost adjacent to the roadway may indicate the number of chevrons to be observed between vehicles traveling over the roadway.

A preferred embodiment of the road-marking system in accordance with the invention is characterized in that the set of active road-marking units is in an active state intermittently. In this embodiment the effect of the dynamic road-marking system is enhanced. The attention level of the driver of a vehicle traveling over a roadway is enhanced by intermittently active road-marking units.

A preferred embodiment of the road-marking system in accordance with the invention is characterized in that the light emitted or reflected by the set of active road-marking units is tuned in response to conditions during the day or during the night. Depending on the contrast level, the intensity of the light emitted or reflected by the set of active road-marking units is increased or lowered. In general, the light intensity during daylight conditions will be higher than the light intensity during dark conditions. In general, the road-marking system according to the invention is responsive to certain weather conditions such as, for example, during fog, rain, black ice, etc., and/or to certain light conditions, such as daylight, twilight, a low position of the sun, night, etc, and/or in tunnels.

Preferably, the road-marking units are shaped in the form of a chevron. Chevrons or V-shaped markings applied on the surface of the roadway are well known to drivers of vehicles. Such chevrons indicate a safe distance between vehicles traveling over the roadway. The distance between vehicles traveling over a roadway can be dynamically influenced in that the chevrons are dynamically switched on or off.

The road-marking units either contain an independent light source or are responsive to an external light source.

A preferred embodiment of the road-marking system in accordance with the invention is characterized in that the light means for emitting light comprises a light-emitting diode. Light-emitting diodes (LEDs) are very suitably applied as light sources in the road-marking units. Preferably, the LED is mounted in the road-marking unit. A relatively high luminous flux is necessary to generate enough light also at ambient light, for example sunlight or light originating from headlights, so that the light beam can be sufficiently brightly observed from a distance. Preferably, the luminous flux of the LED is at least 5 lm during operation.

A preferred embodiment of the road-marking system in accordance with the invention is characterized in that the color of the light emitted by the road-marking units is dependent on the situation. A red, orange, amber, or yellow color emitted by the road-marking units is associated with danger; a green color is associated with comfort and/or safety.

An alternative suitable light source for use in the road-marking system, may be an end portion of an optical fiber. To this end, an alternative embodiment of the road-marking system in accordance with the invention is characterized in that the light means for emitting light is formed by an end portion of an optical fiber. The use of optical fibers has the advantage that the light emitted by the light source is generated in a light generator at a distance from the road-marking unit and transferred from the light generator to the light source by means of optical fibers. The light generator may comprise a light source accommodated in a housing, for example a semiconductor light source such as a discharge lamp, such as a mercury discharge lamp or a LED or a plurality of LEDs. In an attractive variant of this embodiment, the light generator comprises a first end of at least one light waveguide, which optical waveguide is optically coupled, at a second, opposite end, to the light source in the road-marking unit. The light source in the light generator is preferably arranged at a distance from the road-marking unit so that said light source can be readily replaced, for example at the end of its service life. A further advantage of the use of optical waveguides is that the use of optical fibers results in a very efficient use of light, which entails no, or at least very little, luminous pollution. Luminous pollution is to be taken to mean the loss of light caused by the fact that areas are illuminated where illumination is not necessary and/or undesirable. An advantage of the use of optical waveguides with respect to the use of LEDs is that no voltages and electric currents have to be fed to the light source via the road surface in the case of optical fibers. This increases traffic safety. Also in the case of accidents and other calamities, the risk of a flashover or short-circuit, which might cause an undesirable explosion, is precluded.

An alternative preferred embodiment of the road-marking system in accordance with the invention is characterized in that the light means for reflecting light comprises a reflective electrophoretic display device. Contrast is generated by reflection of the light from the available light source such as, for example, sunlight, street light, or headlights of a vehicle. Electrophoretic display devices are based on light-absorbing and/or reflecting particles moving under the influence of an electric field between electrodes provided on opposite substrates. The charged electrophoretic particles are usually colored particles or black and white particles. The application of a suitable voltage across electrically conductive electrodes causes the charged electrophoretic particles to move towards or away from the surface of the electrophoretic layer. In this manner the optical characteristics of the electrophoretic layer change from reflective to non-reflective. An advantage of light means based on the reflection of light in a reflective electrophoretic display device is that power is only needed when the pattern on the road marking is to be changed.

Road-marking systems can be provided in a road surface of the traffic route but also beside and/or above the traffic route, for example on a crash barrier at the side of the traffic route. Preferably, the road-marking system is provided in the surface of the roadway. In an alternative embodiment, the road-marking system is preferably arranged on one or on either side of the roadway.

These and other aspects of the invention will be apparent from and elucidated with reference to the embodiment(s) described hereinafter.

In the drawings:

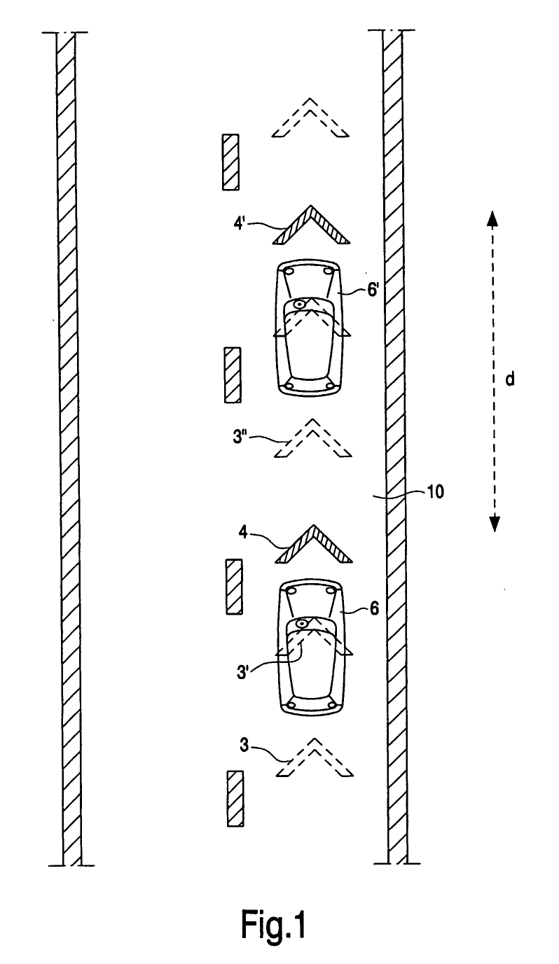

FIG. 1 is a plan view of a road-marking system for influencing the distance between vehicles traveling over a roadway, in accordance with the invention;

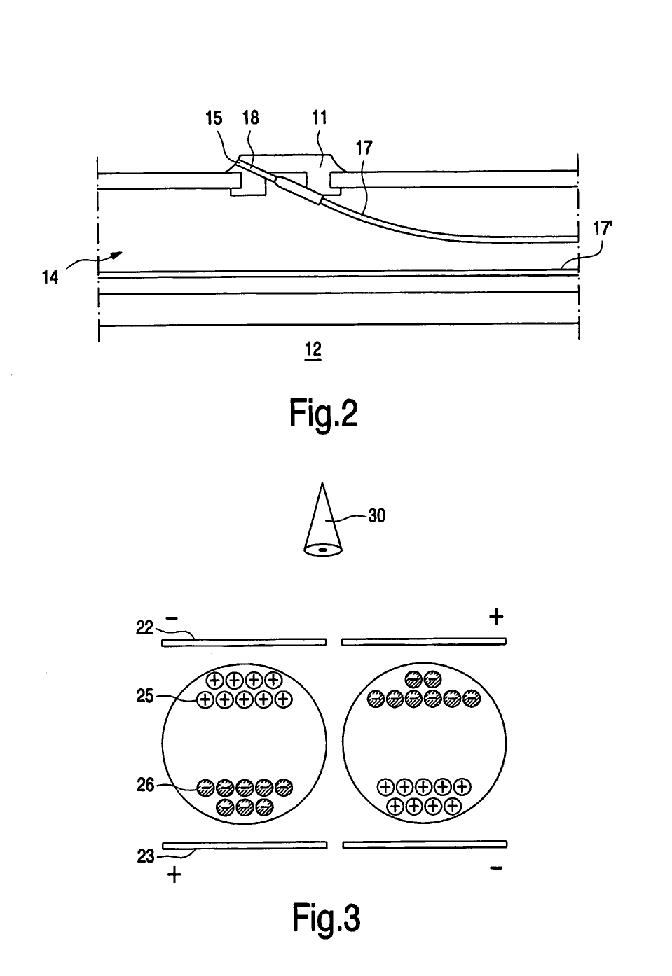

FIG. 2 is a cross-sectional view of part of a road-marking unit comprising an end portion of an optical fiber, and

FIG. 3 is a side view of a light means for a road-marking unit comprising a reflective electrophoretic display device.

The Figures are purely diagrammatic and not drawn to scale. Particularly for clarity, some dimensions are exaggerated strongly. In the drawings, like reference numerals refer to like parts whenever possible.

FIG. 1 schematically shows a plan view of a road-marking system for influencing the distance between vehicles 6, 6′, . . . traveling over a roadway 10. The road-marking system comprises a plurality of road-marking units 3; 3′, 3″, . . . ; 4, 4′, . . . The road-marking units 3; 3′, 3″, . . . ; 4, 4′, . . . are provided with light means for emitting or reflecting light in the direction of a driver of the vehicle 6, 6′, . . . In operation, a set of the road-marking units 4, 4′, . . . is in an active state, while the remainder of the road-marking units 3; 3′, 3″, . . . is in an inactive state. The distance between the active road-marking units 4, 4′, . . . (said distance is indicated with d in FIG. 1) in the set is indicative of the desired distance between the vehicles 6, 6′, . . .

In the example of FIG. 1, the road-marking units 3; 3′, 3″, . . . ; 4, 4′, . . . are shaped as chevrons.

Depending on the traffic density, weather conditions, or other ambient conditions, the road-marking units forming part of the set of active road-marking units 4, 4′, . . . can be changed, thereby dynamically influencing the distance between the vehicles 6, 6′, . . . traveling over a roadway 10. Preferably, the light emitted or reflected by the set of active road-marking units 4, 4′, . . . is tuned in response to conditions during the day and during the night. In order to enhance the attention level of the driver of the vehicle 6, 6′, . . . , the set of active road-marking units 4, 4′, . . . is, preferably, in the active state intermittently.

The light means in the road-marking units may either be an independent light source or be responsive to an external light source.

FIG. 2 diagrammatically shows a cross-sectional view of part of a road-marking unit comprising an end portion of an optical fiber 17. In the example of FIG. 2, the light means is a light source 15 is provided in a base plate 11 which is provided in a profiled holder 12, which light source 15 forms an end portion of an optical fiber 17 provided with a lens 18. A plurality of such optical fibers 17, 17′ is guided through a channel 14.

In an alternative embodiment of the road-marking unit, the light means comprises a light-emitting diode with a luminous flux of at least to 5 lm during operation. Light-emitting diodes (LEDs) are very suitable for use as light sources in the road-marking units.

FIG. 3 very schematically shows a side view of a light means for a road-marking unit comprising a reflective electrophoretic display device. Contrast is generated by reflection of the light from an available light source such as, for example, sunlight, street light, or headlights of a vehicle. Electrophoretic display devices are based on light-absorbing and/or reflecting particles 25, 26 moving under the influence of an electric field between (transparent) electrode layers 22,23 provided on opposite substrates. The charged electrophoretic particles 25, 26 are usually colored particles or black and white particles. The application of a suitable voltage across the electrically conductive electrode layers 22, 23 causes the charged electrophoretic particles 25, 26 to move towards or away from the surface of the electrophoretic layer. In this manner the optical characteristics of the electrophoretic layer change from reflective to non-reflective as viewed by an observer 30. In general, the electrophoretic layer is bi-stable, i.e. the layer retains its state even when the voltage across the layer is absent.

Electrophoretic display devices may, for instance, be applied by a roll-to-roll process on a flexible (plastic) film provided with a transparent conductive electrode layer 22, 23. In the case of a road-marking system, the transparent first conductive electrode layer 22 may be non-patterned. On top of the electrophoretic layer a pressure-sensitive adhesive is applied, by means of which it can be laminated onto a second plastic film provided with a second conductive electrode layer 23, which does not have to be transparent. The application of an appropriate voltage difference across the conductive electrode layers 22, 23 stimulates the travel of the charged electrophoretic particles 25, 26. In general, the electrophoretic layer is bi-stable, i.e. the electrophoretic layer retains its state even when the voltage across the layer is removed/absent (commonly for weeks or months). This results in a road-marking unit being in an active state without consuming energy.

The contrast pigments in the electrophoretic layer are highly reflective and exhibit a good contrast (for example 12:1). The road-marking units with light means in the form of electrophoretic display devices can be manufactured for relatively large areas and can be made viewable at an angle of 180° vertically and 360° vertically, the latter being very effective for a road-marking system operating under daylight conditions. During dark periods (e.g. at night) the light emitted by the headlamp of a vehicle can be reflected by those road-marking units that are in the active state.

Road-marking systems can be provided in a road surface of the traffic route but also beside and/or above the traffic route, for example on a crash barrier at the side of the traffic route. Preferably, the road-marking system is provided in the surface of the roadway. In an alternative embodiment, the road-marking system is preferably arranged on one or on either side of the roadway.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A road-marking system for influencing the distance between vehicles (6, 6′, . . . ) traveling over a roadway (10), comprising:
a plurality of road-marking units (3; 3′, 3″, . . . ; 4, 4′, . . . ),
the road-marking units (3; 3′, 3″, . . . ; 4, 4′, . . . ) being provided with light means for emitting or reflecting light in the direction of a driver of the vehicle (6, 6′, . . . ),
a set of the road-marking units (4, 4′, . . . ), of which in operation a part is in an active state while the remainder of the road-marking units (3; 3′, 3″, . . . ) is in an inactive state,
the distance between the active road-marking units (4, 4′, . . . ) in the set being indicative of the desired distance between the vehicles (6, 6′, . . . ).

2. A road-marking system as claimed in claim 1, characterized in that the set of active road-marking units (4, 4′, . . . ) is in the active state intermittently.

3. A road-marking system as claimed in claim 1, characterized in that the light emitted or reflected by the set of active road-marking units (4, 4′, . . . ) is tuned in response to conditions during the day or during the night.

4. A road-marking system as claimed in claim 1, characterized in that the road-marking units (3; 3′, 3″, . . . ; 4, 4′, . . . ) are shaped as chevrons.

5. A road-marking system as claimed in claim 1, characterized in that the light means for emitting light comprises a light-emitting diode.

6. A road-marking system as claimed in claim 1, characterized in that the light means for emitting light is formed by an end portion of an optical fiber.

7. A road-marking system as claimed in claim 1, characterized in that the light means for reflecting light comprises a reflective electrophoretic display device.

8. A road-marking system as claimed in claim 1, characterized in that the road-marking units (3; 3′, 3″, . . . ; 4, 4′, . . . ) are provided in the surface of the roadway.

9. A road-marking system as claimed in claim 1, characterized in that the road-marking units (3; 3′, 3″, . . . ; 4, 4′, . . . ) are provided on one side or on either side of the roadway (10).
